(19) United States
(12) Patent Application Publication
(10) Pub. No.: US 2026/0283118 A1
(43) Pub. Date: Sep. 24, 2026

(54) TECHNIQUES FOR AUTOMATICALLY MONITORING ANIMAL BEHAVIORS AND GENERATING NOTIFICATIONS

(71) Applicant: DISNEY ENTERPRISES, INC., Burbank, CA (US)

(72) Inventors: Ching-Chien CHEN, Arcadia, CA (US); Isabelle Victoria WANG, Granada Hills, CA (US); Jeremy EATON, Winter Garden, FL (US)

(21) Appl. No.: 19/084,604

(22) Filed: Mar. 19, 2025

(51) Int. Cl. A01K 29/00; G06V 10/82; G06V 40/10

(52) U.S. Cl. CPC A01K 29/005; G06V 10/82; G06V 40/10

(57) ABSTRACT

A computer-implemented technique for monitoring animals includes processing at least one image using a trained machine learning model to determine at least one of one or more animals in the at least one image or one or more behaviors of animals in the at least one image, and transmitting a notification to at least one computing device based on the at least one of one or more animals or one or more behaviors of animals.

### BACKGROUND

### Technical Field

The present disclosure relates generally to computer science, computer vision, machine learning, artificial intelligence (AI), and, more specifically, to techniques for automatically monitoring animal behaviors and generating notifications.

### Description of the Related Art

Animal theme parks, sometimes referred to as zoological theme parks, have become popular around the world. Animal theme parks combine common theme park elements, such as amusement rides, with classic zoo elements, such as exotic animals that are confined within viewing enclosures. In many instances, amusement park elements and animal themes are directly combined, for example when live animals are featured or otherwise employed as part of a themed ride or attraction.

The animals in animal theme parks need to be monitored for various reasons, such as identifying aggressive behaviors between certain animals or removing one animal species that has intruded into an enclosure occupied by an incompatible species. One approach for monitoring animals, including the animals in animal theme parks, is through manual observation by caretakers of those animals.

One drawback of the above approach is that manual observation of animals is highly limited and error prone, oftentimes resulting in the failure to observe important or time-sensitive behaviors. For example, attractions featured around animals are typically set within environments or confined spaces that can be extremely large, and therefore include many areas and habitats that cannot be directly observed by caretakers at all times. Instead, observations are typically made after behavioral events occur, i.e., caretakers are not immediately aware of many events or able to intervene in those events. Currently, no technical infrastructure exists to assist in the monitoring of animals, particularly in real time when behavioral events occur.

As the foregoing illustrates, what is needed in the art are more effective techniques for monitoring animals.

### SUMMARY

One embodiment of the present disclosure sets forth a technique for monitoring animals. The technique includes processing at least one image using a trained machine learning model to determine at least one of one or more animals in the at least one image or one or more behaviors of animals in the at least one image, and transmitting a notification to at least one computing device based on the at least one of one or more animals or one or more behaviors of animals.

At least one advantage of the disclosed techniques is that animals and animal behaviors are detected automatically, allowing more behavioral events to be identified relative to manual observation by caretakers. The disclosed techniques also convert machine learning models to efficient implementations that perform the detections of animals and animal behaviors in real time. These technical advantages provide one or more technological advancements over prior art approaches.

### BRIEF DESCRIPTION OF THE DRAWINGS

So that the manner in which the above recited features of the disclosure can be understood in detail, a more particular description of the disclosure, briefly summarized above, may be had by reference to aspects, some of which are illustrated in the appended drawings. It is to be noted, however, that the appended drawings illustrate only typical aspects of this disclosure and are therefore not to be considered limiting of its scope, for the disclosure may admit to other equally effective aspects.

FIG. 1 conceptually illustrates an animal encounter facility configured to implement one or more embodiments.

FIG. 2 is a more detailed illustration of an animal encounter enclosure of the animal encounter facility of FIG. 1, according to various embodiments.

FIG. 3 is a conceptual block diagram of an animal monitoring platform of the animal encounter facility of FIG. 1, according to various embodiments.

FIG. 4 is a conceptual block diagram of a video analysis module of the animal monitoring platform of FIG. 3, according to various embodiments.

FIG. 5 is a flowchart of method steps for monitoring animals in an animal encounter facility, according to various embodiments.

FIG. 6 is a block diagram of a computing device configured to implement various embodiments.

For clarity, identical reference numbers have been used, where applicable, to designate identical elements that are common between figures. It is contemplated that features of one example aspect may be incorporated in other example aspects without further recitation.

### DETAILED DESCRIPTION

In the following description, numerous specific details are set forth to provide a more thorough understanding of the embodiments of the present disclosure. However, it will be apparent to one of skill in the art that the embodiments of the present disclosure may be practiced without one or more of these specific details.

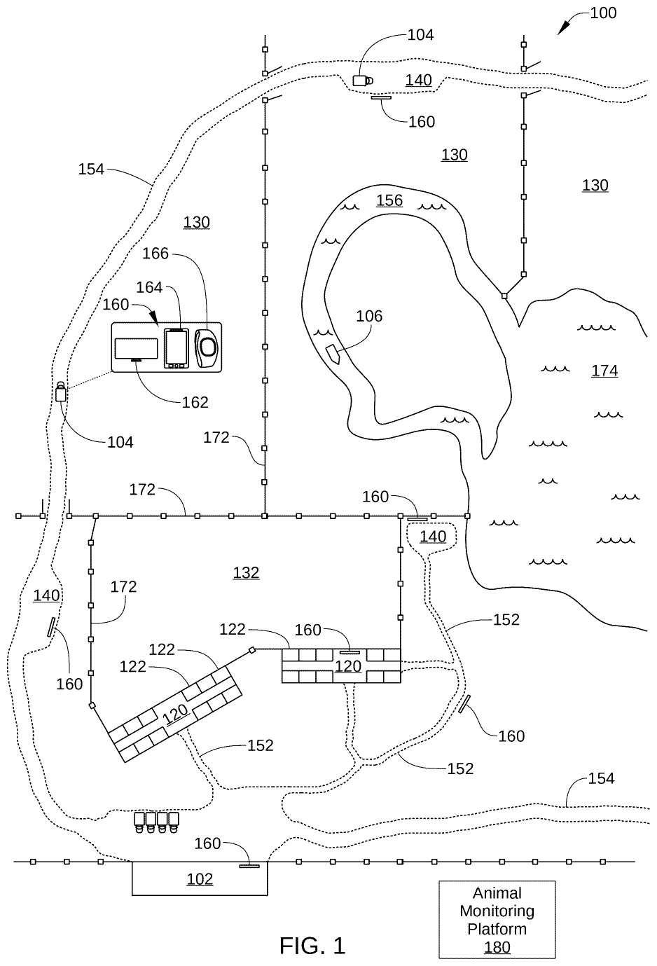

FIG. 1 conceptually illustrates an animal encounter facility 100 configured to implement one or more embodiments. Animal encounter facility 100 can be a zoo, zoological theme park, animal theme park, aquarium, farm, petting zoo, wildlife preserve, safari park, or any other facility that enables encounters with and/or observation of one or more species of animal. In some embodiments, animal encounter facility 100 can further include amusement park features or other elements, such as themed rides, entertainment venues, and/or the like. In the embodiment illustrated in FIG. 1, animal encounter facility 100 includes, without limitation, an entrance 102, one or more indoor encounter structures 120, a plurality of outdoor animal encounter enclosures 130, and a plurality of observation areas 140, all of which are linked together by various foot paths 152, vehicle paths 154, and/or waterways 156. Animal encounter facility 100 further includes various notification devices 160 that are disposed throughout animal encounter facility 100 and are configured to provide real-time notifications regarding the location and type of viewing opportunities within animal encounter facility 100, within a specific indoor encounter structure 120, and/or within a specific outdoor animal encounter enclosure 130. Animal encounter facility 100 further includes an animal monitoring platform 180 for generating real-time notifications relating to animals in animal encounter facility 100 and/or behaviors of the animals. Real-time notifications enable guests to be timely notified of the location of specific animals and animal behavior, thereby providing more opportunities for rewarding animal encounters and greatly enhancing the guest experience. Thus, the guest experiences can be curated based on current animal behavior and can change the guest experiences in real-time.

Each indoor encounter structure 120 includes a plurality of indoor animal display enclosures 122 that can be accessed by the public in an indoor environment. Indoor animal display enclosures 122 contain one or more animal species and enable close viewing thereof. Each indoor animal display enclosure 122 can be an aquarium, an aviary, a glass encased habitat, and/or the like.

Outdoor animal encounter enclosures 130 contain one or more species of animals in environments that can approximate the natural habitats of the contained species. Outdoor animal encounter enclosures 130 are separated from each other with one or more suitable barriers, such as fences 172, water features 174, and/or walled structures (e.g., indoor encounter structure 120). In some examples, outdoor animal enclosures 130 may be separated from each other by features of the terrain (e.g., hills, ravines, or rock formations) or vegetation (e.g., dense plantings of trees, shrubs, or other plants). Thus, animals contained in one outdoor animal encounter enclosure 130 can be safely isolated from guests and/or from animals of an incompatible species located in another outdoor animal encounter enclosure 130. In some embodiments, one or more outdoor animal encounter enclosures 130 are accessible by guests on foot via foot paths 152. Alternatively or additionally, in some embodiments, one or more outdoor animal encounter enclosures 130 are accessible by guests in vehicles 104 via vehicle paths 154. Alternatively or additionally, in some embodiments, one or more outdoor animal encounter enclosures 130 are accessible by guests in boats 106 via waterways 156. Alternatively or additionally, in some embodiments, one or more outdoor animal encounter enclosures 130 are not directly accessible by guests. For example, in the embodiment illustrated in FIG. 1, a predator encounter enclosure 132 is fully enclosed with fences 172 and/or walled structures for the safety of guests and of certain animal species that are incompatible with a predator species disposed within predator encounter enclosure 132.

Notification devices 160 are disposed throughout animal encounter facility 100 and are configured to provide real-time notifications to guests and/or employees of animal encounter facility 100. Thus, in some embodiments, certain notification devices 160 provide real-time notifications to guests regarding viewing opportunities within animal encounter facility 100, within a specific outdoor animal encounter enclosure 130, and/or within a specific area of an outdoor animal encounter enclosure 130. Similarly, in some embodiments, certain notification devices 160 provide real-time notifications to employees of animal encounter facility 100 about an animal-related situation that needs to be addressed or responded, such as an animal in distress or animals exhibiting aggressive behavior towards each other. Examples of such situations include when behavioral anomalies are exhibited by a certain animal (which can possibly indicate distress), when a vehicle path 154 is blocked by an animal (which can halt ongoing vehicle tours), when aggressive or dangerous behavior is exhibited by an animal (which can be dangerous to the animals involved), and when sought-after behaviors are exhibited by certain animals (which can provide a high-quality viewing opportunity to guests).

In some embodiments, a notification device 160 is disposed proximate each indoor animal display enclosure 122 to provide real-time notifications to guests regarding viewing opportunities within animal encounter facility 100, indoor encounter structure 120, and/or a specific indoor animal display enclosure 122. Alternatively or additionally, in some embodiments, one or more notification devices 160 are located elsewhere within each indoor encounter structure 120, such as at an entrance or some centralized location. In some embodiments, a notification device 160 is disposed proximate and/or within each outdoor animal encounter enclosure 130 to provide real-time notifications to guests regarding viewing opportunities within animal encounter facility 100 and/or the associated outdoor animal encounter enclosure 130.

Notification devices 160 can include any computing device that has a suitable wired or wireless connection to animal monitoring platform 180 for receiving real-time notifications and can provide notifications received from animal monitoring platform 180 to a user, such as a guest or employee of animal encounter facility 100. In some embodiments, notification devices 160 display notifications (e.g., using text, icons, maps, images, or other visual content) and/or audibly play notifications (e.g., using voice content, sound effects, etc.) received from animal monitoring platform 180. For example, in some embodiments, a notification device 160 can be disposed at a fixed location within animal encounter facility 100, such as a display screen and/or loudspeaker located at an observation area 140. Alternatively or additionally, in some embodiments, a notification device 160 can be a display screen 162 and/or loudspeakers disposed within a vehicle 104 associated with animal encounter facility 100, such as a service vehicle or a touring vehicle. Alternatively or additionally, in some embodiments, a notification device 160 can be a wireless device associated with animal encounter facility 100 or with a particular guest, such as a smartphone 164, a radio-frequency identification (RFID) device 166 provided by animal encounter facility 100, an audio-tour device rented from or otherwise provided by animal encounter facility 100, a tablet device, an extended reality (XR) headset, a vehicle radio tuned to a specified frequency and/or live-streamed to an infotainment system of a guest vehicle, and/or the like.

In embodiments in which a notification device 160 is implemented as a smartphone 164 or tablet device, notifications can be sent thereto from animal monitoring platform 180 via any technically feasible approach, such as a text message, a push notification, an email (for notifying employees of animal encounter facility 100 on non-urgent information), and/or a notification in an application that is running on the smartphone 164 and is associated with animal encounter facility 100. In some embodiments, the smartphone 164 or tablet device can display and/or play audio notifications that are curated for the specific guest or employee associated with that smartphone 164 or tablet device. In such embodiments, notifications can be sent to a particular smartphone 164 or tablet device based on specific attributes associated with the smartphone 164 or tablet device. Examples of such attributes can include area of expertise and/or work responsibilities of an employee associated with that particular smartphone 164 or tablet device, animal behaviors and/or specific animals indicated to be of interest to a guest associated with that particular smartphone 164 or tablet device (e.g., animal behaviors associated with a favorite animal indicated in a user profile or otherwise declared by a particular guest), a current location within animal encounter facility 100 of that particular smartphone 164 or tablet device, and the like. In some embodiments, one or more attributes associated with the smartphone 164 or tablet device are based on information stored on and/or enter into the smartphone 164 or tablet device.

In embodiments in which a notification device 160 is implemented as an RFID device 166, notifications can be sent thereto from animal monitoring platform 180 via any technically feasible approach, such as a wireless connection. In such embodiments, RFID device 166 can be implemented as a wrist band, a badge, or other wearable electronic device that is provided by or otherwise associated with animal encounter facility 100. In some embodiments, the RFID device 166 can display and/or play audio notifications that are curated for the specific guest or employee associated with that particular RFID device 166. In such embodiments, notifications can be sent to a particular RFID device 166 based on specific attributes associated with that RFID device 166, similar to the description above for the smartphone 164 or tablet device.

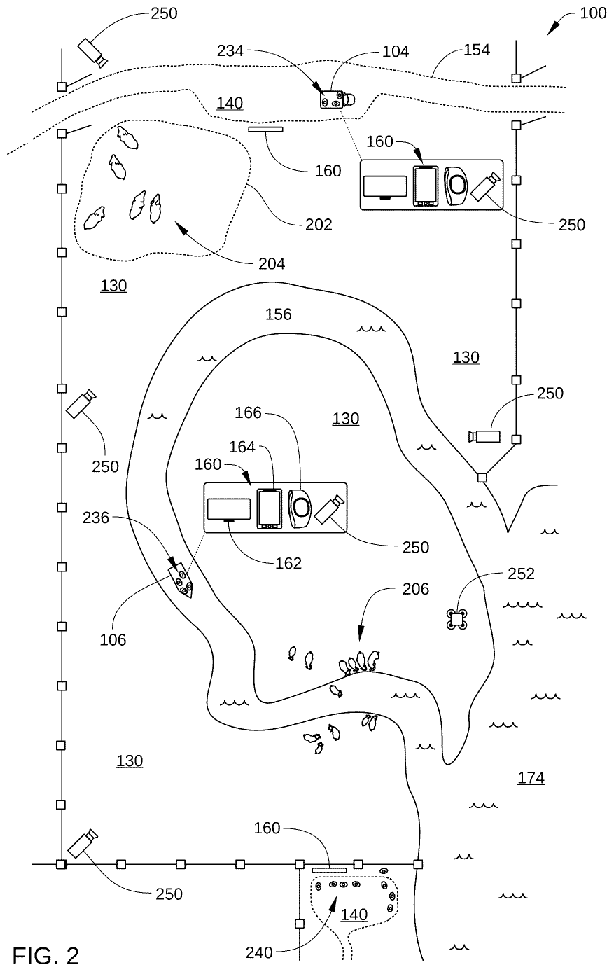

Observation areas 140 are located throughout animal encounter facility 100 to facilitate observation of one or more outdoor animal encounter enclosures 130. In some embodiments, a notification device 160 is disposed proximate each observation area 140 to provide real-time notifications to guests regarding viewing opportunities within animal encounter facility 100 and/or the associated outdoor animal encounter enclosure 130. An example outdoor animal encounter enclosure 130, associated observation areas 140, and various associated notification devices 160 are described in greater detail below in conjunction with FIG. 2.

FIG. 2 is a more detailed illustration of an animal encounter enclosure 130, according to various embodiments. As noted previously, animal encounter enclosure 130 enables guests (e.g., guests 234 in vehicle 104, guests 236 in boat 106, or guests 240 located at observation area 140) to remotely view, encounter, interact with, and/or closely observe animals within animal encounter enclosure 130 (e.g., animals 204 in a roadside viewing area 202 or animals 206 that are near or in waterway 156). Further, one or more notification devices 160 can be disposed within vehicle 104 and/or boat 106, such as a display screen 162, one or more smartphones 164, or an RFID device 166 associated with a particular guest or employee.

Animal encounter enclosure 130 includes a plurality of cameras 250 for continual monitoring of animal encounter enclosure 130. Cameras 250 can include video and/or still-image cameras that generate digital images that are transmitted by a wired and/or wireless connection to animal monitoring platform 180 (shown in FIG. 1). In some embodiments, one or more cameras 250 can be disposed in a fixed location within or proximate to animal encounter enclosure 130. In such embodiments, the one or more cameras 250 can be swivel mounted to facilitate a greater and/or adjustable field of view. Alternatively or additionally, in some embodiments, one or more cameras 250 can be mounted on vehicle 104, boat 106, and/or one or more unmanned aerial vehicles 252. Alternatively or additionally, in some embodiments, one or more cameras 250 can be included in a wireless device associated with a guest and/or employee of animal encounter facility 100, such as a smartphone 164.

In some embodiments, cameras 250 are positioned to observe virtually all areas of animal encounter enclosure 130. In other embodiments, cameras 250 are positioned to observe selected areas of animal encounter enclosure 130, such as areas that are more likely to be frequented by animals 204 and/or animals 206.

Animal encounter enclosure 130 can include a relatively vast outdoor area with various habitats and environments that cannot all be readily observed from a single viewing location. Thus, guests and animal encounter facility 100 employees in one location can typically encounter and observe animals that are not visible to guests and animal encounter facility 100 employees in other locations. For example, in the embodiment illustrated in FIG. 2, guests 234 in vehicle 104 can encounter animals 204 and observe the behaviors and/or interactions of animals 204 in roadside viewing area 202, while animals 204 are not visible to guests 236 in boat 106 or to guests 240 located at observation area 140. Conversely, guests 236 in boat 106 can readily view animals 206 that are near or in waterway 156 and are not visible to guests 234 or guests 240. In some instances, animals 204 may not be immediately visible to guests 234 in vehicle 104 or to guests 236 in boat 106 when a notification of the animals'presence or activity is received at a notification device 160 associated with guests 234 or 236 or an employee in or near vehicle 104 or boat 106. In such instances, vehicle 104 or boat 106 may be driven towards viewing area 202 or a certain portion of waterway 156 upon receiving the notification. Thus, in such instances, a planned course for vehicle 104 or boat 106 can be modified in response to receipt of the notification.

Due to the large areas viewable by guests and employees in a given viewing location, in a conventional animal encounter facility, animal behaviors can oftentimes be missed because the guest or employee is unaware of the behaviors and/or does not know the exact location of the behaviors. According to various embodiments, animal monitoring platform 180 (shown in FIG. 1) provides guests and/or employees with real-time notifications regarding the location of animal species, animal individuals, and/or animal behaviors of interest. In some embodiments, a particular notification can be sent to a specific guest or employee, such as a guest or employee who has indicated interest in a particular species, and in other embodiments, a particular notification can be sent to all guests or employees in animal encounter facility 100 or to all guests or employees in a particular area of animal encounter facility 100. In some embodiments, a particular notification includes one or more of a description of an animal or animals of interest, a detected behavior interest, and/or a location associated with the animal or behavior.

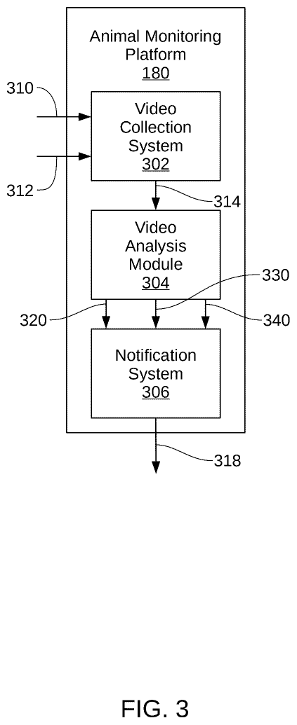

Returning to FIG. 1, animal monitoring platform 180 is a computer-implemented system that can detect, categorize, and track specific animals, animal species, and animal behaviors in real time, and provide real-time notifications to interested parties. Generally, animal monitoring platform 180 employs computer-vision and machine-learning techniques to monitor and detect in real-time specific animal species, animal individuals, and animal behaviors without manual human observations. Based on such computer-implemented monitoring and detection, animal monitoring platform 180 can provide real-time notifications to guests and employees of animal encounter facility 100 regarding animal viewing opportunities, animal-related safety issues, and/or anomalous animal behavior. Further, in some embodiments, animal monitoring platform 180 can learn patterns of behavior of animal species and/or specific animal individuals, for example based on observed seasonal and/or time-of-day behaviors. Animal monitoring platform 180 can be located within animal encounter facility 100 or be implemented remotely. An example embodiment of animal monitoring platform 180 is described in greater detail below in conjunction with FIG. 3.

FIG. 3 is a conceptual block diagram of animal monitoring platform 180, according to various embodiments. As shown, animal monitoring platform 180 includes, without limitation, a video collection system 302, a video analysis module 304, and a notification system 306.

Video collection system 302 receives still images 310 and/or video feeds 312, which are generated by cameras 250, and provides selected images and/or video feeds 314 that are useful for detecting animals and animal behaviors to video analysis module 304. In such cases, the images and/or video feeds 314 can be a subset of all still images and/or video generated by cameras 250 within animal encounter facility 100. In some embodiments, video collection system 302 is included in the server architecture of animal encounter facility 100, and in other embodiments, video collection system 302 is implemented as a separate system.

In some embodiments, the images and/or video feeds 314 can include representative images or video, images or video from cameras 250 that are specifically positioned to observe animals and/or animal behavior, images or video from cameras 250 that have recently observed animals and/or animal behavior, and/or images or video from cameras 250 that are prioritized over other cameras 250. For example, in some embodiments, still images and/or video feeds from cameras 250 that are directed to areas of animal encounter facility 100 that ordinarily do not include animals may be sampled at a very low rate, while still images and/or video feeds from cameras 250 that frequently observe animals are sampled at a very high rate. Alternatively, in some embodiments, images and/or video feeds 314 can include still images and/or video feeds from all cameras 250 in animal encounter facility 100.

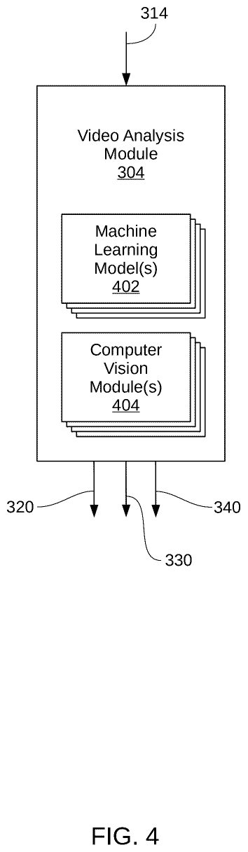

Video analysis module 304 employs one or more computer-vision techniques and/or machine-learning models to detect one or more animals in one or more digital images, which can be standalone images or frames of a video, to determine animal(s) and/or animal behavior(s) in the image(s). In some embodiments, video analysis module 304 determines the current physical location of each detected animal to generate animal location information 340. For example, in some embodiments, video analysis module 304 employs one or more computer-vision techniques and/or machine-learning models to determine the animal location(s). Alternatively, in some embodiments, video analysis module 304 determines the current location of each detected animal based on metadata associated with the still images and/or video feeds, such as metadata indicating the camera(s) that captured the images and/or video feeds. Video analysis module 304 is described in greater detail below in conjunction with FIG. 4.

FIG. 4 is a conceptual block diagram of video analysis module 304, according to various embodiments. As shown, video analysis module 304 receives selected images and/or video feeds 314 and generates detected animal information 320, detected animal behavior information 330, and/or animal location information 340. Detected animal information 320 can include any suitable information relating to animals that are detected in selected images and/or video feeds 314, such as the species, gender, age, etc. of animals that are detected. Detected animal behavior information 330 can include any suitable information relating to behaviors of individual animals and/or groups of animals that are detected in selected images and/or video feeds 314, such as eating, sleeping, playing, fighting, etc. behaviors that are detected. Detected animal location information 340 can include any suitable information indicating the physical locations of one or more animals, such as coordinates of the animal(s), relative locations of the animal(s) with respect to each other and/or landmarks (e.g., specific cameras), etc. Illustratively, video analysis module 304 includes one or more trained machine learning models 402 and one or more computer vision modules 404. Although machine learning model(s) 402 and computer vision module module(s) 404 are shown as being included in video analysis module 304 for illustrative purposes, in some embodiments, machine learning model(s) and/or computer vision module(s) can be distinct from video analysis module 304. For example, in some embodiments, one or more machine learning model(s) and/or computer vision module(s) can execute in a cloud computing environment and be accessed by the video analysis module 304 via, e.g., an application programming interface (API).

Any technically feasible machine learning model(s) 402 can be used in some embodiments. In some embodiments, machine learning model(s) 402 can include one or more object detection models. In such cases, the object detection model(s) can be trained to classify and localize specific animals and/or specific animal behaviors in images that are input into the object detection model(s). The detection of behaviors is also sometimes referred to as “action recognition.” For example, in some embodiments, one object detection model can be a neural network, such as a convolutional neural network (CNN) or transformer-based network, that takes as input an image and outputs bounding boxes around animals as well as annotations of what species of animal is within each bounding box (e.g., detected animal information 320). Machine learning model(s) 402 can be trained in any technically feasible manner in some embodiments. For example, in some embodiments, one or more of the neural networks described herein can be trained (beginning from an untrained model) using previous examples of animals and/or animal behaviors as training data and backpropagation with gradient descent, or a variation thereof. As another example, in some embodiments, the same or another object detection model can be trained to take as input an image and output bounding boxes around animals that, alone or together with other animal(s), exhibit certain behaviors as well as annotations of the behaviors associated with each bounding box (e.g., animal behavior information 330). In such cases, labeled images of the specific animals and/or behaviors that are captured by the same camera that captured one or more of the images and/or video feeds 314, a camera with a similar viewpoint, and/or any other suitable camera can be used as training data to train the object detection model(s). In some embodiments, one or more object detection models can also be trained to detect objects other than animals (e.g., vehicles, humans, trash, etc.) that should or should not be within an enclosure. In some other embodiments, the localization (e.g., generation of bounding boxes) and classification of animals and/or animal behaviors can be performed by different machine learning models 402.

In some embodiments, machine learning model(s) 402 can include one or more generative models. For example, in some embodiments, the generative model(s) can include a trained multimodal model, such as a vision language model. In such cases, the multimodal model can be a neural network that is trained to take as input an image and a text question, and to output a text response. As a specific example, the multimodal model could be an OWL-ViT (Vision Transformer for Open-World Localization) model. OWL-ViT is an open-vocabulary object-detection network trained on a variety of image/text pairs, and can be used to query an image with one or more text queries. Thus, given a text-based query, such as “What animals are visible in this image?”, OWL-ViT searches for and detects target objects described in the text-based query. In some embodiments, the multimodal model can be pre-trained on a large dataset of publicly available images and text. Then, the pre-trained multimodal model can be fine-tuned (i.e., trained again) on a dataset that includes text relevant to specific animals and animal behaviors as well as images of the specific animals and/or behaviors that are captured by the same camera that captured one or more of the images and/or video feeds 314, a camera with a similar viewpoint, and/or any other suitable camera. Thereafter, when provided with an image from the one of the images and/or video feeds 314 and a question such as “What animals are in the image?” or “What are the animals doing in the image?,” the multimodal model can generate a text response describing the animals or animal behaviors (e.g., detected animal information 320 and detected animal behavior information 330), respectively, that appear in the image. Any suitable question(s) can be input, along with images, into the multimodal model in some embodiments. In some embodiments, video analysis module 304 inputs, for each image, one or more predefined questions into the multimodal model (e.g., “What animals are in the image?”, “What are the animals doing in the image?”, “Is any animal behaving aggressively in the image?”, etc.). In some embodiments, video analysis module 304 can input questions from guests and/or employees of animal encounter facility 100 into the multimodal model. For example, a guest or employee could ask, via an application running on a wireless device, “What is animal X doing right now?,” and the wireless device can transmit the question to animal monitoring platform 180 for processing by the multimodal model. Although described herein with respect to text and image inputs into a multimodal model as a reference example, in some embodiments, the multimodal model can also consider other inputs, such as audio input of animal sounds.

In some embodiments, machine learning model(s) 402 can include one or more keypoint detection models. In such cases, the keypoint detection model(s) can include a neural network that is trained to take as input an image and to output keypoints associated with animals in the image. The keypoints can correspond to different anatomical parts of the animals, such as a set of keypoints for the head, shoulder, elbow, paw, etc. of each animal. Using the keypoints, other machine learning model(s) 402 and/or computer vision module(s) 404 can make any suitable determinations. For example, in some embodiments, another machine learning model 402 could be trained to take as input keypoints associated with animals and output behaviors of the animals, alone and/or together. As a specific example, the machine learning model 402 could be trained with labeled images of keypoints to distinguish between keypoints corresponding to aggressive stances, sleeping postures, etc. of one or more animals.

In some embodiments, machine learning model(s) 402 can include one or more models that are trained to determine the locations of animals with respect to each other and/or inside an enclosure (e.g., animal location information 340). In some embodiments, machine learning model(s) 402 can include one or more models that are trained to analyze sequences of images, such as consecutive frames of a video or images of keypoints that are generated from consecutive frames of a video. For example, in some embodiments, the model(s) trained to analyze sequences of images can include neural networks that take as input sequences of images that include keypoints and output animal behaviors.

In some embodiments, machine learning model(s) 402 can include one or more anomaly detection models. In such cases, the anomaly detection model(s) can include neural network(s) that learn patterns of animals and/or animal behaviors from observing the images and/or video feeds 314 over time, and the anomaly detection model(s) can output indications of whether current animals and/or animal behaviors are anomalous (as, e.g., detected animal behavior information 330). For example, the anomaly detection model(s) could learn the pattern of animal behaviors for specific animal species, for an individual animal or group of animals, for a specific location within animal encounter facility 100, for different seasons of the year, and/or for different times of day. Alternatively, in some embodiments, the anomaly detection model(s) can include a trained classification model that classifies images and/or objects therein as normal or anomalous.

In some embodiments, one or more operators of machine learning model(s) 402 can be converted to operators that are defined in a hardware-specific API that permits those machine learning model(s) 402 to execute faster on certain processors. For example, when the processor includes a graphics processing unit (GPU), the hardware-specific API can be an API for high-performance deep learning inference on GPUs that may include a deep learning compiler and optimized kernels. More generally, in some embodiments, the hardware-specific API can be any API that enables accelerated execution of machine learning models on underlying computing hardware. Utilizing the hardware-specific API can allow one or more of machine learning model(s) 402 to execute in real time with a latency of, e.g., a few hundred milliseconds, whereas many conventional machine learning models do not operate with sufficiently small latency to permit the real-time generation of inferences from images.

Any technically feasible computer vision module(s) 404 that implement one or more computer vision techniques can be used in some embodiments. In some embodiments, computer vision module(s) 404 can include a module that determines animal behaviors. For example, in some embodiments, the animal behaviors can be determined based on certain keypoints of two or more animals (e.g., keypoints corresponding to heads of two animals) being within a threshold distance, based on bounding boxes of two or more animals overlapping, and/or the like. In some embodiments, computer vision module(s) 404 can include a module that performs motion filtering. In such cases, the motion filtering can be used to detect certain animal behaviors, such as animals that are not moving. In some embodiments, computer vision module(s) 404 can perform one or more of the functionalities described above in conjunction with the machine learning model(s) 402. For example, in some embodiments, a computer vision module can determine the location of a detected animal within an enclosure (e.g., animal location information 340) based on metadata associated with images and/or video feeds 314 that include the detected animal, such as a camera ID, a camera rotation value, and/or the like.

Any combination of the above machine learning model(s) 402 and/or computer vision module(s) 404, as well as any other suitable models (e.g., a segmentation model, etc.) and/or computer vision modules, can be included in video analysis module 304 in some embodiments, depending on the animals and/or animal behaviors that need to be detected. Further, one or more of machine learning model(s) 402 and/or computer vision module(s) 404, as well as any other suitable models and/or computer vision modules, can be used separately or together as a “stack” in any technically feasible manner. For example, to classify images as including certain animals and animal behaviors, an object detection model could be used. As another example, to classify images as including certain animals and detect keypoints of those animals, an object detection model and a keypoint detection model could be used.

Returning to FIG. 3, notification system 306 generates real-time notifications 318 based on detected animal information 320, detected animal behavior information 330, and/or animal location information 340. Notification system 306 then transmits the notification to at least one notification device 160 (shown in FIG. 1). As noted previously, the approach by which notification system 306 transmits the notification generally depends on the specific notification device 160 to receive the notification. Any suitable notification(s) can be transmitted in some embodiments. In some embodiments, notifications can be transmitted to encourage or discourage certain behaviors by guests or employees of animal encounter facility 100. For example, when a specific animal or behavior is detected, guests who are located near an enclosure of the animal and/or who have indicated a preference for viewing the animal or behavior can be notified of the animal or behavior. As another example, when an animal is detected to be blocking a route through an enclosure, employees located in the enclosure could be notified of the blockage as well as a detour route. As a further example, when anomalous animal behavior is detected, employees could be notified to check on animals to identify a root cause.

In some embodiments, notification system 306 determines which notification devices 160 are to receive a particular notification. For example, in some embodiments, notification system 306 determines whether a particular notification device 160 is to receive a particular notification based on one or more factors. One example of such a factor is a location of a guest who is associated with the notification device or a distance between the guest and a location of an animal species or individual animal referenced in the notification. Another example of such a factor is the location of an employee of animal encounter facility 100 who is associated with the notification device or a distance between the employee and a location of an animal species or individual animal referenced in the notification. As a specific example, based on the location of the employee within an enclosure, notification system 306 could transmit a notification to a wireless device of the employee alerting the employee of the need to avoid a route that is blocked by an animal. Another example of such a factor is an urgency of a notification, where notifications referencing guest or animal safety, more popular animals, more popular behaviors, and shorter-duration behaviors have higher urgency than other notifications. Another example of such a factor is an animal species, an individual animal, and/or an animal behavior that is indicated to be of interest to a particular guest.

In some embodiments, notification system 306 computes one or more scores based on detected animal information 320, detected animal behavior information 330, and/or animal location information 340, and notification system 306 transmits (or does not transmit) notifications based on the computed score(s). For example, in some embodiments, each animal and/or behavior can be assigned a value, and notification system 306 can compute a score as a sum (e.g., a straight sum or a weighted sum) of the values associated with detected animals and/or behaviors. In such cases, notification system 306 can transmit a notification if the score satisfies one or more related thresholds. As a specific example, the score could indicate whether a guest viewing experience at a particular animal encounter enclosure is favorable based on detected animals and/or behaviors. If the score exceeds one threshold indicating a favorable viewing experience, notification system 306 can transmit a notification of the favorable viewing experience. If the score exceeds another threshold indicating an even better viewing experience, notification system 306 can transmit another notification of the better viewing experience.

In some embodiments, a notification sent by notification system 306 to a notification device 160 can include a priority indicator. In such embodiments, the priority indicator can differentiate between different viewing opportunities within animal encounter facility 100 and/or within a specific outdoor animal encounter enclosure 130. For example, in such embodiments, certain viewing opportunities can be associated with a high priority indicator when referenced in a notification, such as a viewing opportunity that is determined to be a rarely occurring viewing opportunity, a viewing opportunity that is in close proximity to the guest receiving the notification, and/or a viewing opportunity that corresponds to a species or behavior of interest to the guest receiving the notification. By contrast, in such embodiments, certain viewing opportunities can be associated with a low priority indicator when referenced in a notification, such as a viewing opportunity that is located relatively far from the guest receiving the notification and/or a viewing opportunity that is in a relatively inaccessible or difficult-to-view location.

Although described herein primarily with respect to generating real-time notifications as a reference example, in some embodiments, detected animal information 320, detected animal behavior information 330, and/or animal location information 340 can also, or alternatively, be stored for subsequent use. For example, in some embodiments, detected animal information 320, detected animal behavior information 330, and/or animal location information 340 can be stored in a database that can be queried and analyzed over time. As a specific example, animals and/or animal behaviors can be stored and tracked over longer periods of time in order to schedule guest viewing experiences at certain locations or times of the day (e.g., times of the day when the animals are awake).

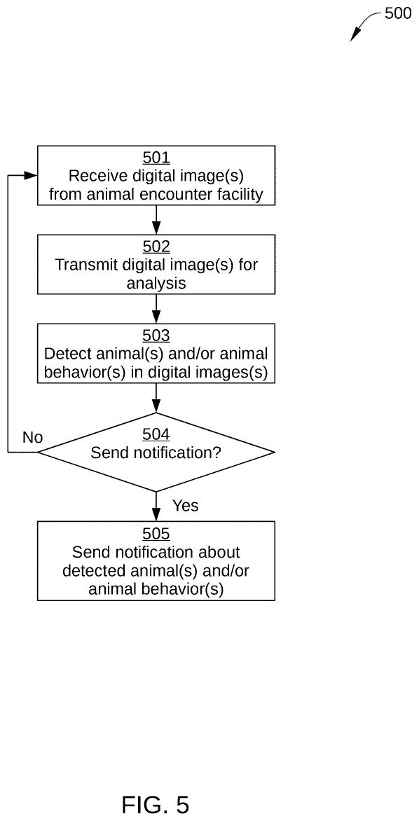

FIG. 5 is a flowchart of method steps for monitoring animals in an animal encounter facility, according to various embodiments. Although the method steps are described with respect to the systems of FIG. 1-4, persons skilled in the art will understand that the method steps may also be performed in conjunction with other systems without exceeding the scope of the disclosure.

As shown, a computer-implemented method 500 begins at step 501, where video collection system 302 of animal monitoring platform 180 receives one or more digital images from cameras located in animal encounter facility 100. For example, in some embodiments, video collection system 302 receives still images 310 and/or video feeds 312 from multiple cameras within animal encounter facility 100, as described above in conjunction with FIG. 2-3. In step 502, video collection system 302 transmits one or more digital images (e.g., image(s) and/or video feed(s) 314) from the digital image(s) that are received in step 501 for analysis by video analysis module 304.

In step 503, video analysis module 304 detects animals and/or animal behaviors based on the digital image(s). In some embodiments, video analysis module 304 employs one or more computer-vision models and/or machine-learning models to classify and/or localize animals and/or behaviors within image(s) (e.g., standalone images or frames of a video), determine the physical locations of animals, identify anomalous behaviors or objects, determine keypoints associated with animals, answer questions about animals and/or behaviors within images, and/or the like, as described above in conjunction with FIG. 4.

In step 504, notification system 306 determines whether to send a notification based on the animals and/or animal behaviors detected in step 503. In some embodiments, notification system 306 can compute a score based on the animals and/or animal behaviors, as described above in conjunction with FIG. 3. In such cases, notification system 306 can determine to send a notification if the score satisfies a threshold. If notification system 306 determines to send a notification, then at step 505, notification system 306 sends the notification about detected animal(s) and/or animal behavior(s) to appropriate notification devices 160. Any suitable notification can be sent, such as a text message, a push notification, an email, and/or a notification in an application that runs on a wireless device. On the other hand, if notification system 306 determines not to send a notification, then method 500 returns to step 501, where video collection system 302 receives one or more additional digital images.

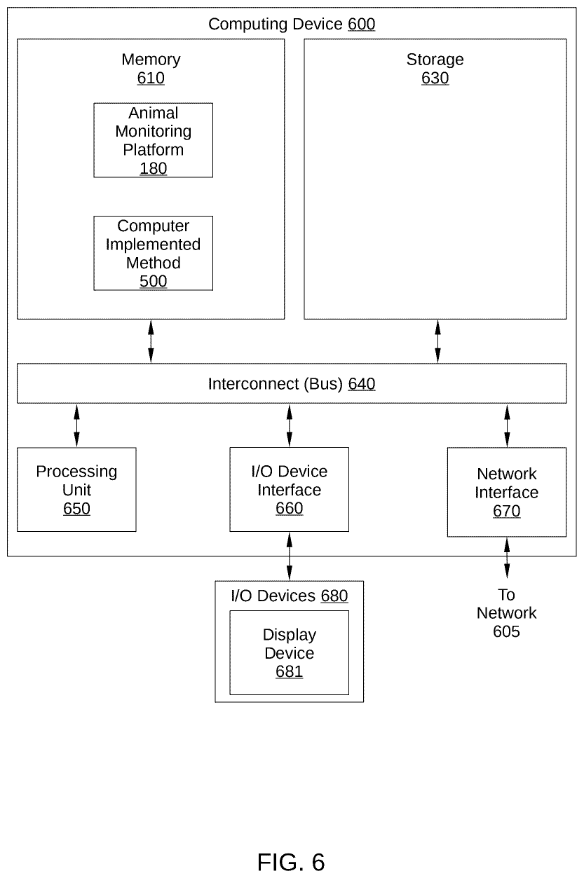

FIG. 6 is a block diagram of a computing device 600 configured to implement various embodiments. Computing device 600 may be a desktop computer, a laptop computer, a tablet computer, or any other type of computing device configured to receive input, process data, generate control signals, and display images. Computing device 600 is configured to execute animal monitoring platform 180, computer-implemented method 500, and/or other suitable software applications, which reside in a memory 610. It is noted that the computing device described herein is illustrative and that any other technically feasible configurations fall within the scope of the present disclosure.

As shown, computing device 600 includes, without limitation, an interconnect (bus) 640 that connects a processing unit 650, an input/output (I/O) device interface 660 coupled to input/output (I/O) devices 680, memory 610, a storage 630, and a network interface 670. Processing unit 650 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 650 may be any technically feasible hardware unit capable of processing data and/or executing software applications, animal monitoring platform 180, computer-implemented method 500, and/or other suitable software applications. Further, in the context of this disclosure, the computing elements shown in computing device 600 may correspond to a physical computing system (e.g., a system in a data center) or may be a virtual computing instance executing within a computing cloud.

I/O devices 680 may include devices capable of providing input, such as a keyboard, a mouse, a touch-sensitive screen, and so forth, as well as devices capable of providing output, such as a display device 681. Additionally, I/O devices 680 may include devices capable of both receiving input and providing output, such as a touchscreen, a universal serial bus (USB) port, and so forth. I/O devices 680 may be configured to receive various types of input from an end-user of computing device 600, and to also provide various types of output to the end-user of computing device 600, such as one or more graphical user interfaces (GUI), displayed digital images, and/or digital videos. In some embodiments, one or more of I/O devices 680 are configured to couple computing device 600 to a network 605.

Network 605 may be any technically feasible type of communications network that allows data to be exchanged between computing device 600 and external entities or devices, such as a smart device, a wearable smart device, a web server, or another networked computing device (not shown). For example, network 605 may include a wide area network (WAN), a local area network (LAN), a wireless (WiFi) network, a Bluetooth network and/or the Internet, among others.

Memory 610 may include a random access memory (RAM) module, a flash memory unit, or any other type of memory unit or combination thereof. Processing unit 650, I/O device interface 660, and network interface 670 are configured to read data from and write data to memory 610. Memory 610 includes various software programs that can be executed by processing unit 650 and application data associated with said software programs, including animal monitoring platform 180, computer-implemented method 500, and/or other suitable software applications. Although shown as executing on a single computing device 600 for illustrative purposes, in some embodiments, functionality of animal monitoring platform 180 and computer-implemented method 500 can be implemented using software and/or hardware on any number of computing devices.

In sum, a computer-implemented animal monitoring platform employs computer-vision techniques and/or machine-learning models to automatically monitor and detect, in real-time, specific animal species, animal individuals, and/or animal behaviors in an animal encounter facility. In some embodiments, the animal monitoring platform includes a video collection system, a video analysis module, and a notification system. The video analysis module employs one or more computer-vision techniques and/or trained machine-learning models to detect one or more animals and/or animal behaviors in digital images (e.g., standalone images or frames of a video) that are captured by cameras at multiple locations within the animal encounter facility. The notification system generates real-time notifications based on scores calculated from the detected animals and/or animal behaviors, and transmits the real-time notifications to appropriate notification devices within the animal encounter facility.

At least one advantage of the disclosed techniques is that animals and animal behaviors are detected automatically, allowing more behavioral events to be identified relative to manual observation by caretakers. The disclosed techniques also convert machine learning models to efficient implementations that perform the detections of animals and animal behaviors in real time. These technical advantages provide one or more technological advancements over prior art approaches.

1. A computer-implemented method for monitoring animals, the method comprising: processing at least one image using a trained machine learning model to determine at least one of one or more animals in the at least one image or one or more behaviors of animals in the at least one image; and transmitting a notification to at least one computing device based on the at least one of one or more animals or one or more behaviors of animals.

2. The computer-implemented method of clause 1, wherein transmitting the notification comprises: computing a score based on the at least one of one or more animals or one or more behaviors of animals; and in response to the score satisfying a threshold, transmitting the notification.

3. The computer-implemented method of clause 1 or 2, wherein computing the score is further based on a location associated with the computing device.

4. The computer-implemented method of any of clauses 1-3, wherein computing the score is further based on a user preference.

5. The computer-implemented method of any of clauses 1-4, wherein the trained machine learning model comprises a trained generative model, and wherein processing the at least one image comprises inputting the at least one image and a text question relating to animals into the trained generative model that outputs the at least one of one or more animals or one or more behaviors of animals.

6. The computer-implemented method of any of clauses 1-5, wherein the trained machine learning model comprises a trained object detection model, and wherein processing the at least one image comprises inputting the at least one image into the trained object detection model that outputs the at least one of one or more animals or one or more behaviors of animals.

7. The computer-implemented method of any of clauses 1-6, wherein the trained machine learning model comprises a trained keypoint detection model, and wherein processing the at least one image comprises: inputting the at least one image into the trained keypoint detection model that outputs one or more keypoints; and determining the at least one of one or more animals or one or more behaviors of animals based on the one or more keypoints.

8. The computer-implemented method of any of clauses 1-7, wherein the trained machine learning model comprises one or more first operators that are converted from one or more second operators, and the one or more first operators accelerate execution of the trained machine learning model on at least one processor.

9. The computer-implemented method of any of clauses 1-8, wherein transmitting the notification is further based on a motion filtering of the at least one image.

10.The computer-implemented method of any of clauses 1-9, wherein the at least one computing device includes one or more of a wireless device, a display device, or a server.

11.In some embodiments, one or more non-transitory computer-readable media store instructions that, when executed by at least one processor, cause the at least one processor to perform the steps of: processing at least one image using a trained machine learning model to determine at least one of one or more animals in the at least one image or one or more behaviors of animals in the at least one image; and transmitting a notification to at least one computing device based on the at least one of one or more animals or one or more behaviors of animals.

12.The one or more non-transitory computer-readable media of clause 11, wherein transmitting the notification comprises one of sending a text message to one or more wireless devices, sending a push notification to one or more wireless devices, sending a message to an application running on one or more wireless devices, sending a message for display to a vehicle-mounted display device, sending a message for display to a fixed display device, sending an email to a server, or sending a message to a server for storage in a database.

13.The one or more non-transitory computer-readable media of clauses 11 or 12, wherein the at least one image is captured by at least one of a camera disposed within an animal enclosure, a camera disposed at a location proximate an animal enclosure, a camera mounted on a vehicle, a camera mounted on an unmanned aerial vehicle, or a camera included in a wireless device.

14.The one or more non-transitory computer-readable media of any of clauses 11-13, wherein the instructions, when executed by the at least one processor, further cause the at least one processor to perform the step of determining, based on the at least one image, one or more physical locations of the at least one of one or more animals or one or more behaviors, wherein the notification indicates the one or more physical locations.

15.The one or more non-transitory computer-readable media of any of clauses 11-14, wherein the instructions, when executed by the at least one processor, further cause the at least one processor to perform the step of performing, based on one or more example images that include the one or more animals or the one or more behaviors of animals, one or more operations to train an untrained machine learning model to generate the trained machine learning model.

16.The one or more non-transitory computer-readable media of any of clauses 11-15, wherein transmitting the notification comprises: computing a score based on the at least one of one or more animals or one or more behaviors of animals; and in response to the score satisfying a threshold, transmitting the notification.

17.The one or more non-transitory computer-readable media of any of clauses 11-16, wherein computing the score is further based on a location associated with the computing device.

18.The one or more non-transitory computer-readable media of any of clauses 11-17, wherein computing the score is further based on a user preference.

19.The one or more non-transitory computer-readable media of any of clauses 11-18, wherein the trained machine learning model comprises a trained generative model, and wherein processing the at least one image comprises inputting the at least one image and a text question relating to animals into the trained generative model that outputs the at least one of one or more animals or one or more behaviors of animals.

20.In some embodiments a system includes: a memory storing instructions; and one or more processors, that when executing the instructions, are configured to perform the steps of: processing at least one image using a trained machine learning model to determine at least one of one or more animals in the at least one image or one or more behaviors of animals in the at least one image, and transmitting a notification to at least one computing device based on the at least one of one or more animals or one or more behaviors of animals.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The disclosure has been described above with reference to specific embodiments. Persons of ordinary skill in the art, however, will understand that various modifications and changes may be made thereto without departing from the broader spirit and scope of the disclosure as set forth in the appended claims. For example, and without limitation, although many of the descriptions herein refer to specific types of application data, content servers, and client devices, persons skilled in the art will appreciate that the systems and techniques described herein are applicable to other types of application data, content servers, and client devices. The foregoing description and drawings are, accordingly, to be regarded in an illustrative rather than a restrictive sense.

What is claimed is:

1. A computer-implemented method for monitoring animals, the method comprising:
processing at least one image using a trained machine learning model to determine at least one of one or more animals in the at least one image or one or more behaviors of animals in the at least one image; and
transmitting a notification to at least one computing device based on the at least one of one or more animals or one or more behaviors of animals.

2. The computer-implemented method of claim 1, wherein transmitting the notification comprises:
computing a score based on the at least one of one or more animals or one or more behaviors of animals; and
in response to the score satisfying a threshold, transmitting the notification.

3. The computer-implemented method of claim 2, wherein computing the score is further based on a location associated with the computing device.

4. The computer-implemented method of claim 2, wherein computing the score is further based on a user preference.

5. The computer-implemented method of claim 1, wherein the trained machine learning model comprises a trained generative model, and wherein processing the at least one image comprises inputting the at least one image and a text question relating to animals into the trained generative model that outputs the at least one of one or more animals or one or more behaviors of animals.

6. The computer-implemented method of claim 1, wherein the trained machine learning model comprises a trained object detection model, and wherein processing the at least one image comprises inputting the at least one image into the trained object detection model that outputs the at least one of one or more animals or one or more behaviors of animals.

7. The computer-implemented method of claim 1, wherein the trained machine learning model comprises a trained keypoint detection model, and wherein processing the at least one image comprises:
inputting the at least one image into the trained keypoint detection model that outputs one or more keypoints; and
determining the at least one of one or more animals or one or more behaviors of animals based on the one or more keypoints.

8. The computer-implemented method of claim 1, wherein the trained machine learning model comprises one or more first operators that are converted from one or more second operators, and the one or more first operators accelerate execution of the trained machine learning model on at least one processor.

9. The computer-implemented method of claim 1, wherein transmitting the notification is further based on a motion filtering of the at least one image.

10. The computer-implemented method of claim 1, wherein the at least one computing device includes one or more of a wireless device, a display device, or a server.

11. One or more non-transitory computer-readable media storing instructions that, when executed by at least one processor, cause the at least one processor to perform the steps of:
processing at least one image using a trained machine learning model to determine at least one of one or more animals in the at least one image or one or more behaviors of animals in the at least one image; and
transmitting a notification to at least one computing device based on the at least one of one or more animals or one or more behaviors of animals.

12. The one or more non-transitory computer-readable media of claim 11, wherein transmitting the notification comprises one of sending a text message to one or more wireless devices, sending a push notification to one or more wireless devices, sending a message to an application running on one or more wireless devices, sending a message for display to a vehicle-mounted display device, sending a message for display to a fixed display device, sending an email to a server, or sending a message to a server for storage in a database.

13. The one or more non-transitory computer-readable media of claim 11, wherein the at least one image is captured by at least one of a camera disposed within an animal enclosure, a camera disposed at a location proximate an animal enclosure, a camera mounted on a vehicle, a camera mounted on an unmanned aerial vehicle, or a camera included in a wireless device.

14. The one or more non-transitory computer-readable media of claim 11, wherein the instructions, when executed by the at least one processor, further cause the at least one processor to perform the step of determining, based on the at least one image, one or more physical locations of the at least one of one or more animals or one or more behaviors, wherein the notification indicates the one or more physical locations.

15. The one or more non-transitory computer-readable media of claim 11, wherein the instructions, when executed by the at least one processor, further cause the at least one processor to perform the step of performing, based on one or more example images that include the one or more animals or the one or more behaviors of animals, one or more operations to train an untrained machine learning model to generate the trained machine learning model.

16. The one or more non-transitory computer-readable media of claim 11, wherein transmitting the notification comprises:
computing a score based on the at least one of one or more animals or one or more behaviors of animals; and
in response to the score satisfying a threshold, transmitting the notification.

17. The one or more non-transitory computer-readable media of claim 16, wherein computing the score is further based on a location associated with the computing device.

18. The one or more non-transitory computer-readable media of claim 16, wherein computing the score is further based on a user preference.

19. The one or more non-transitory computer-readable media of claim 11, wherein the trained machine learning model comprises a trained generative model, and wherein processing the at least one image comprises inputting the at least one image and a text question relating to animals into the trained generative model that outputs the at least one of one or more animals or one or more behaviors of animals.

20. A system, comprising:
a memory storing instructions; and
one or more processors, that when executing the instructions, are configured to perform the steps of:
processing at least one image using a trained machine learning model to determine at least one of one or more animals in the at least one image or one or more behaviors of animals in the at least one image, and
transmitting a notification to at least one computing device based on the at least one of one or more animals or one or more behaviors of animals.
